(19) United States
(12) Patent Application Publication
(10) Pub. No.: US 2023/0116859 A1
(43) Pub. Date: Apr. 13, 2023

(54) AXIAL FLOW FAN, AIR-SENDING DEVICE, AND REFRIGERATION CYCLE APPARATUS

(71) Applicant: Mitsubishi Electric Corporation, Tokyo (JP)

(72) Inventors: Takahide TADOKORO, Tokyo (JP); Akihide NAKAJIMA, Tokyo (JP); Shota HOSOMI, Tokyo (JP); Katsuyuki YAMAMOTO, Tokyo (JP)

(21) Appl. No.: 17/913,695

(22) PCT Filed: May 20, 2020
(86) PCT No.: PCT/JP2020/019948

§ 371 Date: Sep. 22, 2022

(51) Int. Cl. F04D 29/38; F04D 19/00

(52) U.S. Cl. CPC F04D 29/384; F04D 19/002

(57) ABSTRACT

An axial flow fan includes a hub and a blade provided around the hub and having a leading edge and a trailing edge. The blade has a thickness portion. The thickness portion includes a first thickness portion located adjacent to the leading edge and a second thickness portion located adjacent to the trailing edge. A virtual circle centered on the rotation axis and passing through both the first thickness portion and the second thickness portion of the blade is a reference circle, an intersection at which the reference circle intersects an edge portion of the first thickness portion is a first intersection, an intersection at which the reference circle intersects an edge portion of the second thickness portion is a second intersection, an intersection of the reference circle and the leading edge is a first edge portion, an intersection of the reference circle and the trailing edge is a second edge portion, a straight line passing through the rotation axis and the first intersection is a thickness portion first straight line, a straight line passing through the rotation axis and the second intersection is a thickness portion second straight line, a straight line passing through the rotation axis and the first edge portion is an edge portion first straight line, a straight line passing through the rotation axis and the second edge portion is an edge portion second straight line, an angle between the thickness portion first straight line and the edge portion first straight line is a phase angle θ1, and an angle between the thickness portion second straight line and the edge portion second straight line is a phase angle θ2. The phase angle θ1 is larger than the phase angle θ2.

### TECHNICAL FIELD

The present disclosure relates to an axial flow fan including a blade, an air-sending device including the axial flow fan, and a refrigeration cycle apparatus including the air-sending device, and in particular, relates to the form of the blade.

### BACKGROUND ART

A typical axial flow fan includes multiple blades arranged around a circumferential surface of a cylindrical boss. The blades are rotated in response to torque applied to the boss, thereby sending a fluid. In the axial flow fan, rotation of the blades causes the fluid between the blades to collide with the surfaces of the blades. On each surface with which the fluid collides, a pressure increases to press and move the fluid in a rotational axial direction, which is along the axis of rotation of the blades.

Such axial flow fans include a developed axial flow fan including a blade having a root, a leading edge, a leading tip, a trailing edge, a trailing tip, and an outer edge (refer to, for example, Patent Literature 1). The root in the axial flow fan disclosed in Patent Literature 1 is a tapered slope that radially extends from the boss to the blade. The tapered slope can increase the strength of the blade.

### CITATION LIST

### Patent Literature

Patent Literature 1: Japanese Unexamined Patent Application Publication No. 2013-217316

### SUMMARY OF INVENTION

### Technical Problem

In the axial flow fan disclosed in Patent Literature 1, a gas collides with a tapered portion provided at the leading edge of the blade upon reaching the leading edge of the blade, resulting in an increase in flow resistance. For an axial flow fan including a blade having a root with no tapered portion, it is difficult to increase the strength of the blade and increase the rigidity of the blade.

In response to the above issue, it is an object of the present disclosure to provide an axial flow fan that achieves an increase in rigidity of a blade and a reduction in flow resistance of the blade, an air-sending device including the axial flow fan, and a refrigeration cycle apparatus including the air-sending device.

### Solution to Problem

An axial flow fan according to an embodiment of the present disclosure includes a hub configured to be driven to rotate and serve as a rotation axis and a blade provided around the hub and having a leading edge and a trailing edge, the blade having, at a root on the hub side thereof, a thickness portion being a protrusion provided at a blade surface of the blade, wherein a phase angle θ1 is larger than a phase angle θ2 where with a virtual line passing through a midpoint of the blade in a circumferential direction of the blade being a center line, the thickness portion includes a first thickness portion being on the leading edge side of the center line and a second thickness portion being on the trailing edge side of the center line, and in a plan view seen in an axial direction of the rotation axis, a virtual circle around the rotation axis as a center thereof, passing through an outermost one of virtual circles passing through both the first thickness portion and the second thickness portion, is a reference circle, an intersection of the reference circle and an edge portion of the first thickness portion, the intersection being at an extremity in a rotation direction of the blade is a first intersection, an intersection of the reference circle and an edge portion of the second thickness portion, the intersection being at an extremity in an anti-rotation direction, being inverse of the rotation direction, of the blade is a second intersection, an intersection of the reference circle and the leading edge is a first edge portion, an intersection of the reference circle and the trailing edge is a second edge portion, a virtual straight line passing through the rotation axis and the first intersection is a thickness portion first straight line, a virtual straight line passing through the rotation axis and the second intersection is a thickness portion second straight line, a virtual straight line passing through the rotation axis and the first edge portion is an edge portion first straight line, a virtual straight line passing through the rotation axis and the second edge portion is an edge portion second straight line, an angle between the thickness portion first straight line and the edge portion first straight line is the phase angle θ1, and an angle between the thickness portion second straight line and the edge portion second straight line is the phase angle θ2.

An air-sending device according to another embodiment of the present disclosure includes the axial flow fan with the above-described configuration, a driving source configured to apply a driving force to the axial flow fan, a bell mouth covering a part of an outer circumferential edge of the blade, the part being adjacent to the trailing edge, and a casing containing the axial flow fan and the driving source.

A refrigeration cycle apparatus according to still another embodiment of the present disclosure includes the air-sending device with the above-described configuration and a refrigerant circuit including a condenser and an evaporator. The air-sending device is configured to send air to at least the condenser or the evaporator.

### Advantageous Effects of Invention

According to the embodiment of the present disclosure, the axial flow fan is configured such that the phase angle θ1 is larger than the phase angle θ2. In other words, the axial flow fan is configured such that the thickness portion on the leading edge side of the blade is recessed relative to the leading edge of the blade toward the trailing edge. Such a configuration allows a reduction in resistance to the flow of a gas to the leading edge. Furthermore, the blade of the axial flow fan has a blade thickness increased by the thickness portion on the trailing edge side of the blade, leading to an increase in strength of the blade at the trailing edge. This results in an increase in rigidity of the blade.

### BRIEF DESCRIPTION OF DRAWINGS

FIG. 1 is a perspective view of an axial flow fan according to Embodiment 1 illustrating a schematic configuration of the axial flow fan.

FIG. 2 is a front view of the axial flow fan according to Embodiment 1 illustrating a schematic form of a blade.

FIG. 3 is a schematic sectional view of the axial flow fan taken along line A-A in FIG. 2.

FIG. 4 is a conceptual diagram illustrating a cross-section of the blade taken along line B-B extending along a reference circle in FIG. 2.

FIG. 5 is a schematic diagram illustrating an exemplary air flow along the blade of the axial flow fan according to Embodiment 1.

FIG. 6 is a front view of the axial flow fan according to Embodiment 1 illustrating a schematic form of the blade.

FIG. 7 is a schematic sectional view of the axial flow fan taken along line C-C in FIG. 6.

FIG. 8 is a conceptual diagram of an axial flow fan according to Embodiment 2 illustrating a cross-section of a blade taken along line B-B extending along the reference circle in FIG. 2.

FIG. 9 is a front view of an axial flow fan according to Embodiment 3 illustrating a schematic form of a blade 20.

FIG. 10 is a conceptual diagram of an axial flow fan according to Embodiment 3 illustrating a cross-section of a blade taken along line B-B extending along the reference circle in FIG. 9.

FIG. 11 is a conceptual diagram illustrating the relationship between the air flow and the blade of the axial flow fan according to Embodiment 3.

FIG. 12 is a conceptual diagram of an axial flow fan according to Embodiment 4 illustrating a cross-section of a blade taken along line B-B extending along the reference circle in FIG. 2.

FIG. 13 is a front view of an axial flow fan according to Embodiment 5 illustrating a schematic form of a blade.

FIG. 14 is a front view of an axial flow fan according to Embodiment 6 illustrating a schematic configuration of the axial flow fan.

FIG. 15 is a front view of the axial flow fan according to Embodiment 6 illustrating a schematic form of a blade.

FIG. 16 is a front view of an axial flow fan according to Embodiment 7 illustrating a schematic form of a blade.

FIG. 17 is a schematic diagram of a refrigeration cycle apparatus according to Embodiment 8.

FIG. 18 is a perspective view of an outdoor unit, serving as an air-sending device, as viewed from where an air outlet is located.

FIG. 19 is a top view of the outdoor unit illustrating the configuration of the outdoor unit.

FIG. 20 is a perspective view of the outdoor unit with a fan grille removed.

FIG. 21 is a perspective view of the outdoor unit with the fan grille, a front panel, and other parts removed illustrating an internal configuration of the outdoor unit.

### DESCRIPTION OF EMBODIMENTS

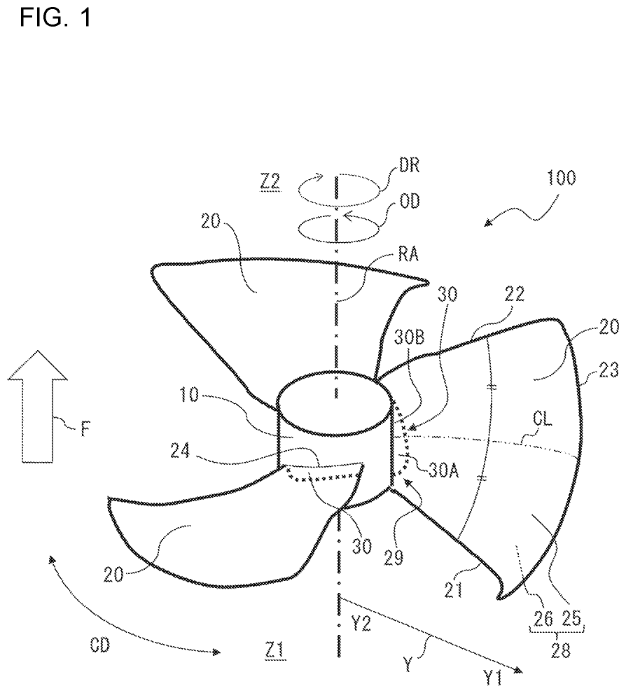

An axial flow fan according to one or more embodiments, an air-sending device according to an embodiment, and a refrigeration cycle apparatus according to an embodiment will be described below with reference to the drawings. Note that the relationship between the relative dimensions, the forms, and other conditions of components in the following figures including FIG. 1 may differ from those of actual ones. Furthermore, note that components designated by the same reference signs in the following figures are the same components or equivalents. This note applies to the entire description herein. For the sake of understanding, terms representing directions, such as “upper”, “lower”, “right”, “left”, “front”, and “rear”, will be used as appropriate. These terms are used herein only for the purpose of convenience of description and are not intended to restrict the arrangement and orientations of devices or parts.

### Embodiment 1

### [Axial Flow Fan 100]

FIG. 1 is a perspective view of an axial flow fan 100 according to Embodiment 1 illustrating a schematic configuration of the axial flow fan, In FIG. 1, an arrow DR represents a rotation direction DR, in which the axial flow fan 100 rotates, an arrow OD represents an anti-rotation direction OD, which is the inverse of the direction in which the axial flow fan 100 rotates, and a double arrow CD represents a circumferential direction CD along the circumference of the axial flow fan 100. The circumferential direction CD includes the rotation direction DR and the anti-rotation direction OD.

In FIG. 1, an open arrow F represents a fluid flow direction F. In the fluid flow direction F, a Z1 side relative to the axial flow fan 100 is an upstream side relative to the axial flow fan 100 in the flow direction in which the fluid or air flows, and a Z2 side relative to the axial flow fan 100 is a downstream side relative to the axial flow fan 100 in the flow direction of the air. In other words, the Z1 side is an air inlet side of the axial flow fan 100, and the Z2 side is an air outlet side of the axial flow fan 100.

In FIG. 1, the Y axis represents a radial direction of the axial flow fan 100 relative to a rotation axis RA thereof. A location Y1 is closer to an outer circumferential side of the axial flow fan 100 than a location Y2, and the location Y2 is closer to an inner circumferential side of the axial flow fan 100 than the location Y1 In other words, a Y2 side of the axial flow fan 100 is the inner circumferential side of the axial flow fan 100, and a Y1 side of the axial flow fan 100 is the outer circumferential side of the axial flow fan 100.

The axial flow fan 100 according to Embodiment 1 will be described with reference to FIG. 1. The axial flow fan 100 is a device that produces a fluid flow. The axial flow fan 100 is included in, for example, an air-conditioning apparatus or a ventilation apparatus. The axial flow fan 100 rotates about the rotation axis RA in the rotation direction DR to produce a fluid flow. The fluid is, for example, a gas, such as air.

As illustrated in FIG. 1, the axial flow fan 100 includes a hub 10 connected to a rotating shaft of a driving source, such as a motor (not illustrated), and multiple blades 20 arranged around the hub 10 and each having a leading edge 21 and a trailing edge 22. In the axial flow fan 100 of FIG. 1, the adjacent blades 20 are connected by the hub 10. Examples of the axial flow fan 100 include a bossless fan with no boss, or having a structure in which the leading edge and the trailing edge of the adjacent blades 20 of the multiple blades 20 merge into a continuous surface with no boss.

### (Hub 10)

The hub 10 is connected to the rotating shaft of the driving source, such as a motor (not illustrated). For example, the hub 10 may be cylindrical or may be flat. The hub 10 only needs to be connected to the rotating shaft of the driving source, as described above. The hub 10 may have any shape.

The hub 10 is driven by, for example, a motor (not illustrated), to rotate and serve as the rotation axis RA. The hub 10 rotates about the rotation axis RA. The rotation direction DR of the axial flow fan 100 is a clockwise direction as represented by the arrow DR in FIG. 1. The rotation direction DR of the axial flow fan 100 is not limited to the clockwise direction. The hub 10 may rotate counterclockwise in a modification in which the blades 20 are changed in attachment angle or orientation, for example.

### (Blades 20)

Each blade 20 extends outward in the radial direction from the hub 10. The multiple blades 20 are arranged radially outward in the radial direction from the hub 10. The multiple blades 20 are spaced apart from each other in the circumferential direction CD. Although the axial flow fan 100 including three blades 20 is illustrated in Embodiment 1, the number of blades 20 may be any number other than three.

Each blade 20 has the leading edge 21, the trailing edge 22, an outer edge 23, and an inner edge 24. The leading edge 21 is located on a forward side of the blade 20 in the rotation direction DR. In other words, the leading edge 21 is located in front of the trailing edge 22 in the rotation direction DR. The leading edge 21 is located upstream of the trailing edge 22 in the direction of a fluid flow that is generated by the axial flow fan 100.

The trailing edge 22 is located on a backward side of the blade 20 in the rotation direction DR. In other words, the trailing edge 22 is located behind the leading edge 21 in the rotation direction DR. The trailing edge 22 is located downstream of the leading edge 21 in the direction of the fluid flow generated by the axial flow fan 100. The axial flow fan 100 has the leading edge 21, serving as a blade end facing in the rotation direction DR of the axial flow fan 100, and the trailing edge 22, serving as a blade end opposite the leading edge 21 in the rotation direction DR.

The outer edge 23 is a portion that extends in the rotation direction DR to connect the outermost part of the leading edge 21 to the outermost part of the trailing edge 22. The outer edge 23 is located at an end of the blade 20 that is adjacent to the outer circumferential side of the axial flow fan 100 in the radial direction (along the Y axis), and serves as an outer circumferential edge of the blade 20. The outer edge 23 is arcuate as viewed in a direction parallel to the rotation axis RA. The outer edge 23 may have any other shape as viewed in the direction parallel to the rotation axis RA. When viewed in the direction parallel to the rotation axis RA, the outer edge 23 has a longer length than the inner edge 24 in the circumferential direction CD. The lengths of the outer edge 23 and the inner edge 24 in the circumferential direction CD may have any other relationship.

The inner edge 24 is a portion that extends in the rotation direction DR to connect the innermost part of the leading edge 21 to the innermost part of the trailing edge 22. The inner edge 24 defines an end of the blade 20 that is adjacent to the inner circumferential side of the axial flow fan 100 in the radial direction (along the Y axis), and serves as a root of the blade 20. The inner edge 24 is arcuate as viewed in the direction parallel to the rotation axis RA. The inner edge 24 may have any other shape as viewed in the direction parallel to the rotation axis RA. The inner edge 24 of the blade 20 is joined to the hub 10. For example, the inner edge 24 of the blade 20 is integrally formed with an outer circumferential wall of the hub 10 having a cylindrical shape.

Each of the blades 20 is inclined relative to a plane perpendicular to the rotation axis RA such that a pressure surface 25 faces in the rotation direction DR and such that a suction surface 26 faces in the direction opposite to the rotation direction DR. The blades 20 each having blade surfaces 28 send a fluid by pressing the fluid located between the blades 20 with the blade surfaces 28 as the axial flow fan 100 rotates. The pressure surface 25 is one of the blade surfaces 28 that presses the fluid and that experiences an increase in pressure. The suction surface 26 is the other surface that is opposite the pressure surface 25 and that experiences a reduction in pressure. The surface of the blade 20 on the upstream side (Z1 side) in the fluid flow direction F is the suction surface 26, and the other surface thereof on the downstream side (Z2 side) is the pressure surface 25.

### (Details of Blades 20)

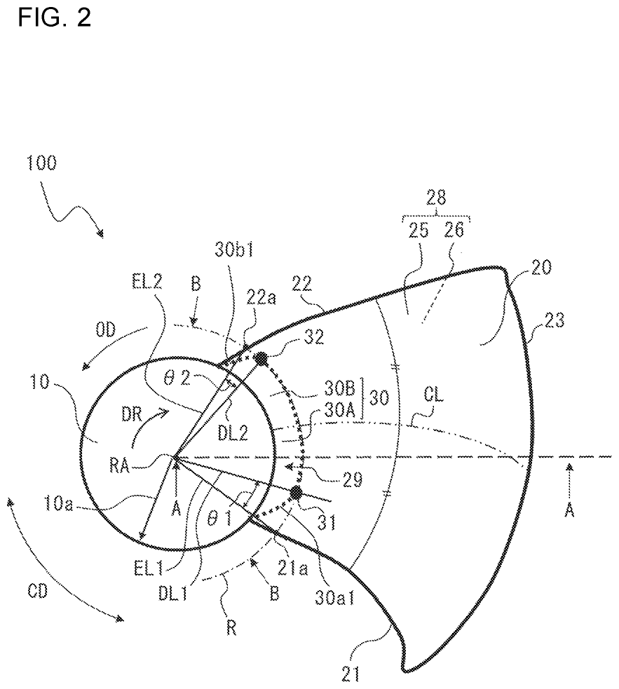

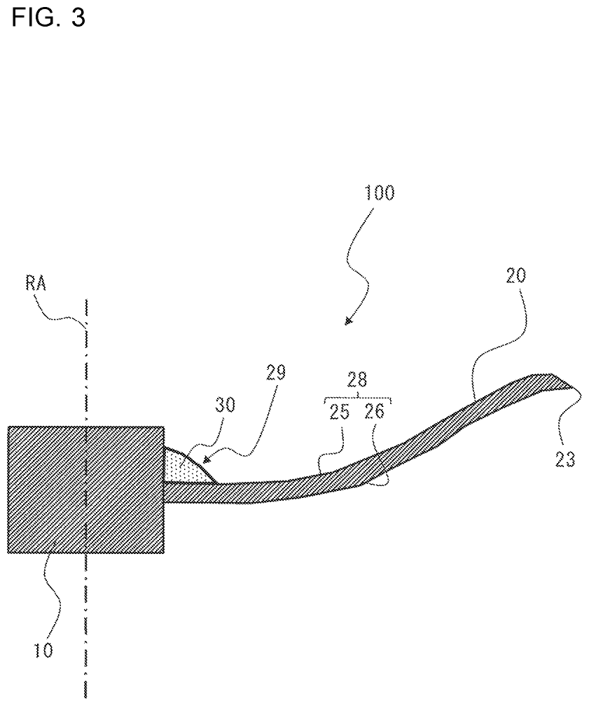

FIG. 2 is a front view of the axial flow fan 100 according to Embodiment 1 illustrating a schematic form of the blade 20. FIG. 3 is a schematic sectional view of the axial flow fan 100 taken along line A-A in FIG. 2. FIG. 2 illustrates only one blade 20 of the multiple blades 20 for description of the form of the blade 20, and the other blades 20 are omitted from depiction. FIG. 3 illustrates a cross-section of the axial flow fan 100 in the axial and radial directions.

### (Thickness Portion 30)

As illustrated in FIGS. 2 and 3, the blade 20 has a thickness portion 30 located at a root 29, which is adjacent to the hub 10, of the blade 20. The thickness portion 30 is a protrusion provided at the blade surface 28 of the blade 20. The thickness portion 30 is provided at at least the pressure surface 25 or the suction surface 26 of the blade 20. FIGS. 2 and 3 illustrate a form in which the thickness portion 30 is provided at the pressure surface 25 of the blade 20.

The thickness portion 30 is a protruding or thickened portion of the blade 20. In other words, the thickness portion 30 is a thick portion of the blade 20 that is thicker than a portion having an average thickness of the blade 20. Examples of the thickness portion 30 include, but are not limited to, a fillet and a rib.

The thickness portion 30 extends from the inner edge 24 toward the outer edge 23 in the radial direction. For example, the thickness portion 30 is provided to connect the side of the cylindrical hub 10 to the blade surface 28 of the blade 20. The thickness portion 30 of each of the adjacent blades 20 connected by the hub 10 is provided closer to the outer circumferential side than a hub outside diameter 10a in the radial direction. The thickness portion 30 extends in the circumferential direction CD. For example, the thickness portion 30 is provided along the side of the cylindrical hub 10.

As illustrated in FIG. 2, a virtual line passing through the midpoint of the blade 20 in the circumferential direction CD is defined as a center line CL. The thickness portion 30 includes a first thickness portion 30A located closer to the leading edge 21 than the center line CL and a second thickness portion 30B located closer to the trailing edge 22 than the center line CL.

As illustrated in FIG. 2, in a plan view seen from a point of view in an axial direction of the rotation axis RA, a virtual circle around the rotation axis RA as the center thereof and passing through the outermost one of virtual circles passing through both the first thickness portion 30A and the second thickness portion 30B of the blade 20 is defined as a reference circle R.

An intersection at which the reference circle R intersects an edge portion 30a1 of the first thickness portion 30A and that is at an extremity in the rotation direction DR of the blade 20 is defined as a first intersection 31. In addition, an intersection at which the reference circle R intersects an edge portion 30b1 of the second thickness portion 30B and that is at an extremity in the anti-rotation direction OD of the blade 20 is defined as a second intersection 32. In other words, the second intersection 32 is an intersection at an extremity in a direction that is the inverse of the rotation direction DR of the blade 20.

An intersection of the reference circle R and the leading edge 21 is defined as a first edge portion 21a, and an intersection of the reference circle R and the trailing edge 22 is defined as a second edge portion 22a. The second intersection 32 may coincide with the second edge portion 22a. In this case, the second intersection 32 is located at the trailing edge 22.

A virtual straight line passing through the rotation axis RA and the first intersection 31 is defined as a thickness portion first straight line DL1, and a virtual straight line passing through the rotation axis RA and the second intersection 32 is defined as a thickness portion second straight line DL2.

A virtual straight line passing through the rotation axis RA and the first edge portion 21a is defined as an edge portion first straight line EL1, and a virtual straight line passing through the rotation axis RA and the second edge portion 22a is defined as an edge portion second straight line EL2.

An angle between the thickness portion first straight line DL1 and the edge portion first straight line EL1 is defined as a phase angle θ1, and an angle between the thickness portion second straight line DL2 and the edge portion second straight line EL2 is defined as a phase angle θ2. In the case where the second intersection 32 coincides with the second edge portion 22a, the phase angle θ2 is zero (phase angle θ2=0).

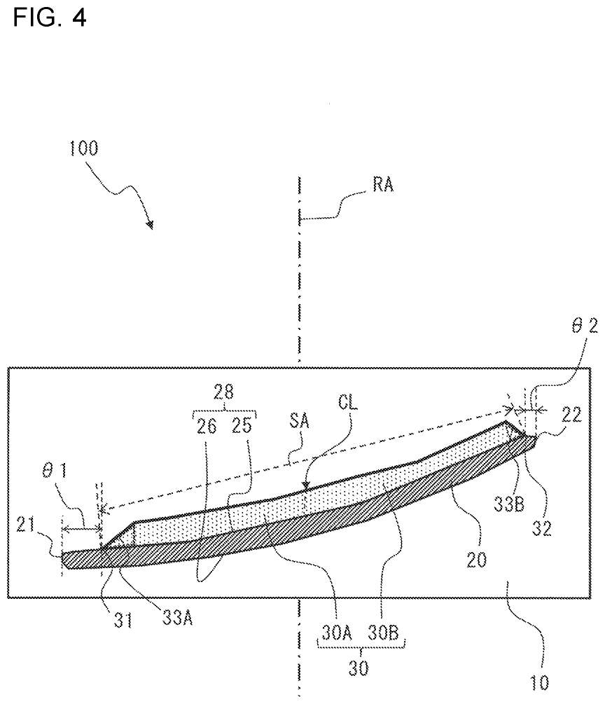

FIG. 4 is a conceptual diagram illustrating a cross-section of the blade 20 taken along line B-B extending along the reference circle R in FIG. 2. An extent SA of the thickness portion 30 represents the extent of the thickness portion 30 located at positions with the same radius. As illustrated in FIGS. 2 and 4, the axial flow fan 100 is configured such that the phase angle θ1 is larger than the phase angle θ2 (phase angle θ1>phase angle θ2). In the axial flow fan 100, therefore, a distance from the leading edge 21 to the thickness portion 30 is longer than a distance from the trailing edge 22 to the thickness portion 30. In other words, the thickness portion 30 in the form of a single portion is closer to the trailing edge 22 than to the leading edge 21 as viewed as a whole.

As illustrated in FIG. 4, the first thickness portion 30A of the thickness portion 30 includes a first tip portion 33A, which is a tip portion adjacent to the leading edge 21, in a cross-section of the thickness portion 30 taken along the reference circle R or a cross-section of the thickness portion 30 taken along a circle parallel to the reference circle R. The first tip portion 33A is tapered. The first tip portion 33A defines a slope and has a thickness increasing in a direction from the leading edge 21 to the trailing edge 22.

The second thickness portion 30B of the thickness portion 30 includes a second tip portion 33B, which is a tip portion adjacent to the trailing edge 22, in the cross-section of the thickness portion 30 taken along the reference circle R or a cross-section of the thickness portion 30 taken along a circle parallel to the reference circle R. The second tip portion 33B is tapered. The second tip portion 33B defines a slope and has a thickness increasing in a direction from the trailing edge 22 to the leading edge 21.

### [Operation of Axial Flow Fan 100]

When the axial flow fan 100 rotates in the rotation direction DR illustrated in FIG. 1, each blade 20 presses ambient air with the pressure surface 25, thus generating an air flow in the direction F in FIG. 1. The rotation of the axial flow fan 100 causes a pressure difference between the pressure surface 25 and the suction surface 26 of the blade 20. A pressure at the pressure surface 25 is larger than a pressure at the suction surface 26, or the pressure at the suction surface 26 is smaller than that at the pressure surface 25.

### [Advantages of Axial Flow Fan 100]

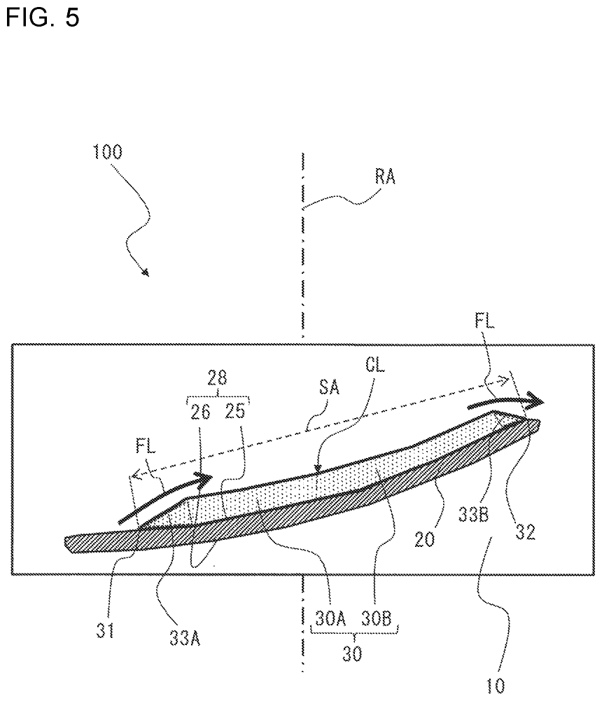

FIG. 5 is a schematic diagram illustrating an exemplary air flow FL along the blade 20 of the axial flow fan 100 according to Embodiment 1. Advantages of the axial flow fan 100 will now be described with reference to FIGS. 2 and 5. As illustrated in FIGS. 2 and 5, the phase angle θ1 is larger than the phase angle θ2 in the axial flow fan 100. The axial flow fan 100 is configured such that a part of the thickness portion 30 of each blade 20 that is located adjacent to the leading edge 21 of the blade 20 is recessed relative to the leading edge 21 toward the trailing edge 22. Such a configuration allows a reduction in resistance to the flow of a gas to the leading edge 21. In addition, the blade 20 of the axial flow fan 100 has a blade thickness increased by the thickness portion 30 at the trailing edge 22 of the blade 20, leading to an increase in strength of the blade 20. This results in an increase in rigidity of the blade 20.

More specifically, the axial flow fan 100 is configured such that the distance between the leading edge 21 and the thickness portion 30 is larger than the distance between the trailing edge 22 and the thickness portion 30. Therefore, the leading edge 21 of each blade 20 of the axial flow fan 100 has no thickness portion 30, serving as a resistance to the flow of a gas to the blade 20. This allows a reduction in resistance to the flow of a gas to the blade 20, as compared with the blade 20 with the leading edge 21 having the thickness portion 30. In other words, the blade surface 28, along which the gas flows upon reaching the leading edge 21, at the leading edge 21 of each blade 20 of the axial flow fan 100 allows a reduction in resistance to the flow of the gas to the blade 20.

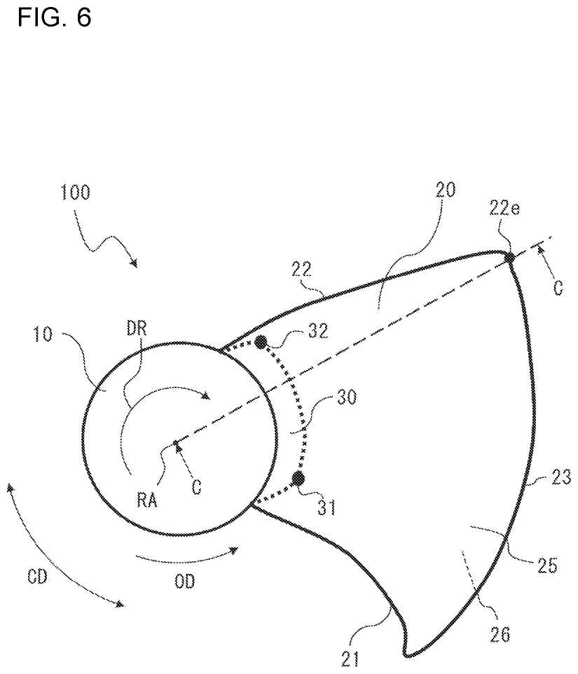

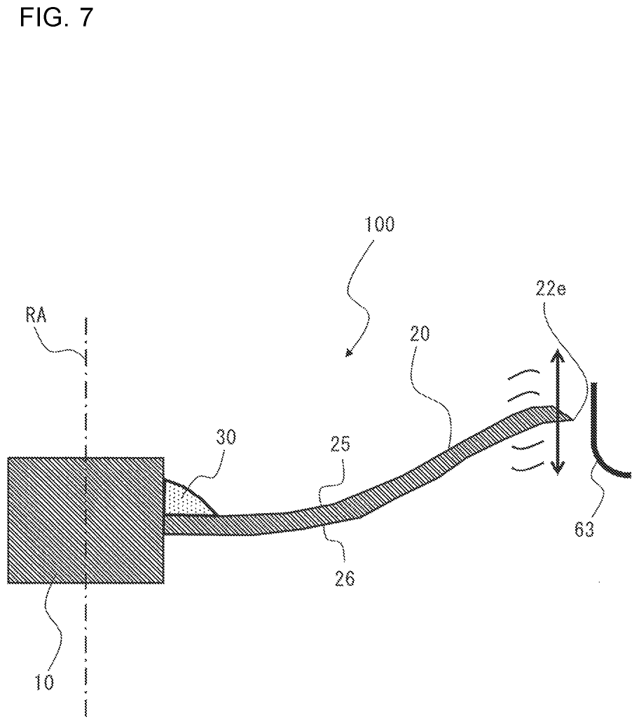

FIG. 6 is a front view of the axial flow fan 100 according to Embodiment 1 illustrating a schematic form of the blade 20. FIG. 7 is a schematic sectional view of the axial flow fan 100 taken along line C-C in FIG. 6. The cross-section of FIG. 7 taken along line C-C is a cross-section taken along a straight line passing through the rotation axis RA and a trailing edge end 22e, serving as an outer end of the trailing edge 22. Advantages and effects of the thickness portion 30 provided at the trailing edge 22 will be further described with reference to FIGS. 6 and 7.

The axial flow fan 100 is configured such that the thickness portion 30 is located in proximity to the trailing edge 22 of each blade 20, as compared with the thickness portion 30 located adjacent to the leading edge 21 of the blade 20. Alternatively, the axial flow fan 100 is configured such that the trailing edge 22 of each blade 20 has the thickness portion 30. The axial flow fan 100 is therefore configured such that the thickness of the thickness portion 30 is added to the blade thickness at the trailing edge 22 of each blade 20, as compared with the blade thickness at the leading edge 21 of the blade 20. The thickened blade thickness increases the strength of the blade 20, resulting in an increase in rigidity of the blade 20 at the trailing edge 22, as compared with that at the leading edge 21.

It is assumed herein that the axial flow fan 100 including the thickness portions 30 is disposed in, for example, an air-sending device. The relationship between the axial flow fan 100 and a bell mouth 63 will now be described with reference to FIG. 7. As described above, the axial flow fan 100 is configured such that the thickness of the thickness portion 30 is added to the blade thickness at the trailing edge 22 of each blade 20, as compared with the blade thickness at the leading edge 21 of the blade 20. The thickened blade thickness increases the strength of the blade 20, resulting in an increase in rigidity of the blade 20 at the trailing edge 22, as compared with that at the leading edge 21.

Such a configuration of the axial flow fan 100 can reduce vibration of the blade 20 that is caused by operation (rotation) of the axial flow fan 100 or that is caused by a change in atmospheric pressure at the trailing edge end 22e of the blade 20 in proximity to the bell mouth 63. In the axial flow fan 100, the thickness portion 30 reduces vibration of the blade 20, thus reducing air flow turbulence that is created by the blade 20 due to vibration of the blade 20. This results in a reduction in noise caused by air flow turbulence.

With the above-described advantages and effects, the axial flow fan 100 achieves an increase in rigidity of the blade 20 and a reduction in flow resistance of the blade 20.

The thickness portion 30 is provided at the pressure surface 25 of each blade 20. Typically, a motor (not illustrated) is attached to the axial flow fan such that the motor is located adjacent to the suction surface of the blade 20. To avoid interference with an air flow flowing through a space between the blade 20 and the motor, a sufficient space is preferably left between the blade 20 and the motor. To leave a sufficient space between the blade 20 and the motor, the thickness portion 30 preferably needs to be provided at the pressure surface 25, which is remote from the motor. Therefore, such a configuration, in which the thickness portion 30 is provided at the pressure surface 25, of the axial flow fan 100 prevents interference with the flow of a gas flowing through a space between the fan and a peripheral part.

The thickness portion 30 includes the first tip portion 33A, which is the tip portion adjacent to the leading edge 21 and is tapered. Such a portion of the thickness portion 30 that is adjacent to the leading edge 21 of the blade 20 has a small thickness that is added to the blade thickness. This allows a reduction in resistance to the flow of air to the blade 20, as compared with a case where the first tip portion 33A is not tapered. In addition, the first tip portion 33A allows an air flow to flow along the blade 20, so that the air flow smoothly flows without separating from the blade 20 upon reaching the blade 20.

The thickness portion 30 includes the second tip portion 33B, which is the tip portion adjacent to the trailing edge 22 and is tapered. Therefore, the blade 20 allows an air flow to smoothly flow along the tapered second tip portion 33B at the trailing edge 22, thus reducing a tip vortex at the trailing edge 22. The term “tip vortex” refers to a vortex of air at a tip of the blade 20 caused by the difference in pressure between the pressure surface 25 and the suction surface 26 of the blade 20. A tip vortex leads to additional energy consumption. Reducing a tip vortex increases the efficiency of the axial flow fan 100, thus reducing the power consumption. A tip vortex generates noise. Reducing a tip vortex reduces noise associated with rotation of the blade 20.

### Embodiment 2

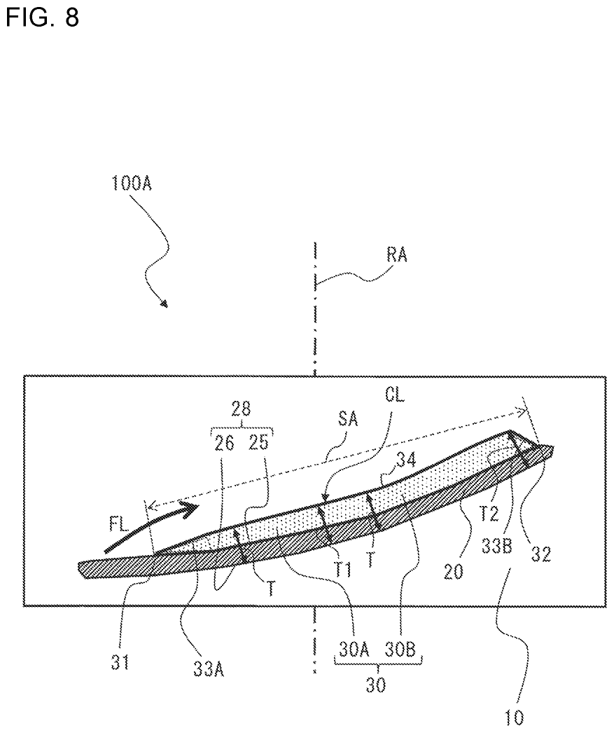

FIG. 8 is a conceptual diagram of an axial flow fan 100A according to Embodiment 2 illustrating a cross-section of a blade 20 taken along line B-B extending along the reference circle R in FIG. 2. The axial flow fan 100A according to Embodiment 2 will be described with reference to FIG. 8. The axial flow fan 100A according to Embodiment 2 specifies the thickness of the thickness portion 30. The same components and parts as those of the axial flow fan 100 in FIGS. 1 to 9 are designated by the same reference signs, and a description thereof is omitted.

A blade height T is defined as a distance between the blade surface 28 with no thickness portion 30 and a ridge line 34 of the thickness portion 30 between the first tip portion 33A and the second tip portion 33B. In the form of the axial flow fan 100A of FIG. 8, the blade surface 28 with no thickness portion 30 is the suction surface 20. The ridge line 34 defines an end opposite the suction surface 26 in the axial direction of the rotation axis RA. The ridge line 34 defines a ridge of the thickness portion 30 protruding in a cross-section of the blade 20 taken along the reference circle R or a circle parallel to the reference circle R, and defines an opposite edge of the thickness portion 30 from the suction surface 26. The axial flow fan 100A is configured such that the blade height T adjacent to the trailing edge 22 is larger than the blade height T adjacent to the leading edge 21.

More specifically, the axial flow fan 100A is configured such that a maximum blade height T2 of the second thickness portion 3013 is larger than a maximum blade height T1 of the first thickness portion 30A.

The blade 20 of the axial flow fan 100A preferably has a form in which the blade height T gradually increases in the direction from the leading edge 21 to the trailing edge 22.

### [Advantages of Axial Flow Fan 100A]

The axial flow fan 100A is configured such that the blade height T adjacent to the trailing edge 22 is larger than the blade height T adjacent to the leading edge 21 In the axial flow fan 100A, therefore, the tip portion of the thickness portion 30 adjacent to the leading edge 21 is thin, resulting in a reduction in resistance to the flow of air to the blade 20. The axial flow fan 100A is configured such that the thickness of the thickness portion 30 is added to the blade thickness at the trailing edge 22 of the blade 20, as compared with the blade thickness at the leading edge 21 of the blade 20. The thickened blade thickness increases the strength of the blade 20, resulting in an increase in rigidity of the blade 20 at the trailing edge 22, as compared with that at the leading edge 21. In the axial flow fan 100A, the thickness portion 30 achieves an increase in rigidity of the blade 20, thus reducing vibration of the blade 20. In the axial flow fan 100A, the thickness portion 30 reduces vibration of the blade 20, thus reducing air flow turbulence caused by vibration of the blade 20. This results in a reduction in noise caused by air flow turbulence.

The axial flow fan 100A is configured such that the maximum blade height T2 of the second thickness portion 30B is larger than the maximum blade height T1 of the first thickness portion 30A. The axial flow fan 100A with such a configuration achieves both a reduction in flow resistance at the leading edge 21 and an increase in rigidity at the trailing edge 22.

The blade 20 of the axial flow fan 100A is formed such that the blade height T gradually increases in the direction from the leading edge 21 to the trailing edge 22, In the axial flow fan 100A, therefore, a gradual increase in blade thickness allows an air flow to smoothly flow along the blade 20, thus reducing separation of the air flow from the blade 20. This reduces turbulence of the air flow. Since the blade thickness adjacent to the leading edge 21 is smaller than the blade thickness adjacent to the trailing edge 22, the axial flow fan 100 achieves a reduction in resistance to the flow of air entering the fan.

### Embodiment 3

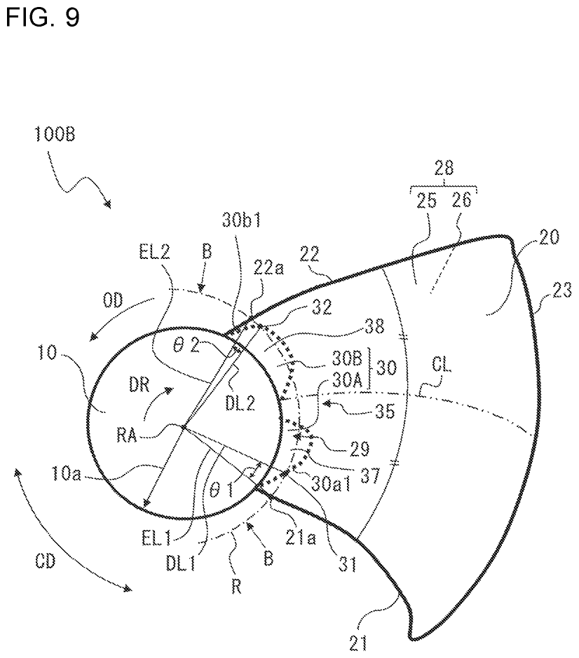

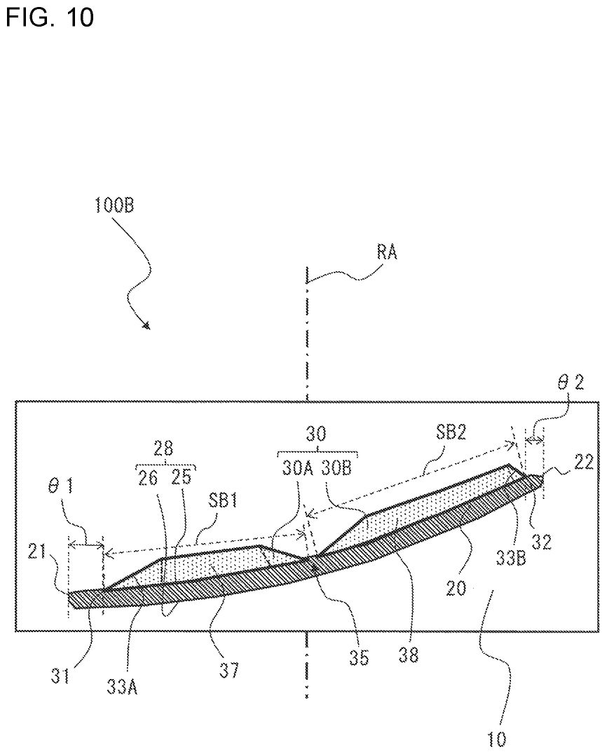

FIG. 9 is a front view of an axial flow fan 100B according to Embodiment 3 illustrating a schematic form of a blade 20. FIG. 10 is a conceptual diagram of the axial flow fan 100E according to Embodiment 3 illustrating a cross-section of the blade 20 taken along line B-B extending along the reference circle R in FIG. 9. The axial flow fan 100E according to Embodiment 3 will be described with reference to FIGS. 9 and 10. The axial flow fan 100E according to Embodiment 3 specifies the form of the thickness portion 30. The same components and parts as those of the axial flow fan 100 and the other axial flow fan in FIGS. 1 to 8 are designated by the same reference signs, and a description thereof is omitted.

The thickness portion 30 of the axial flow fan 100B according to Embodiment 3 includes segments arranged in the circumferential direction CD. The thickness portion 30 of each blade 20 includes a leading thickness segment 37 located closest to the leading edge 21 and a trailing thickness segment 38 located closest to the trailing edge 22. The axial flow fan 100E is configured such that the thickness portion 30 of the blade 20 includes discrete segments arranged in the circumferential direction CD at a certain radius.

The thickness portion 30 illustrated in FIGS. 9 and 10 includes an intermediate part 35, in which the thickness portion 30 is not formed, the leading thickness segment 37 located between the intermediate part 35 and the leading edge 21, and the trailing thickness segment 38 located between the intermediate part 35 and the trailing edge 22. An extent SB1 of the leading thickness segment 37 and an extent SB2 of the trailing thickness segment 38 are located at the same radius.

The thickness portion 30 of the axial flow fan 100 of FIGS. 9 and 10 includes two segments arranged in the circumferential direction CD. The thickness portion 30 may include three or more segments. For the thickness portion 30 including multiple segments arranged in the circumferential direction CD, the leading thickness segment 37 of each blade 20 is a segment of the thickness portion 30 that is located closest to the leading edge 21 in the circumferential direction CD, and the trailing thickness segment 38 is a segment of the thickness portion 30 that is located closest to the trailing edge 22 in the circumferential direction CD.

As illustrated in FIGS. 9 and 10, the leading thickness segment 37 has the first intersection 31, and the trailing thickness segment 38 has the second intersection 32. The axial flow fan 100B according to Embodiment 3 is configured such that the phase angle θ1 is larger than the phase angle θ2 (phase angle θ1>phase angle θ2). In the axial flow fan 100B, therefore, a distance from the leading edge 21 to the thickness portion 30 is longer than a distance from the trailing edge 22 to the thickness portion 30.

### [Advantages of Axial Flow Fan 100B]

The thickness portion 30 of the axial low fan 100B according to Embodiment 3 includes the segments arranged in the circumferential direction CD. The thickness portion 30 of each blade 20 includes the leading thickness segment 37 located closest to the leading edge 21 and the trailing thickness segment 38 located closest to the trailing edge 22. The segmentation of the thickness portion 30 provides the intermediate part 35, in which the thickness portion 30 is eliminated. The elimination of the thickness portion 30 in the intermediate part 35 results in a reduction in weight of the axial flow fan 100B according to Embodiment 3.

The axial flow fan 100B according to Embodiment 3 is configured such that the phase angle θ1 is larger than the phase angle θ2 (phase angle θ1>phase angle θ2). Like the axial flow fan 100 according to Embodiment 1, the axial flow fan 100B according to Embodiment 3 therefore achieves both a reduction in flow resistance at he leading edge 21 and an increase in rigidity at the trailing edge 22.

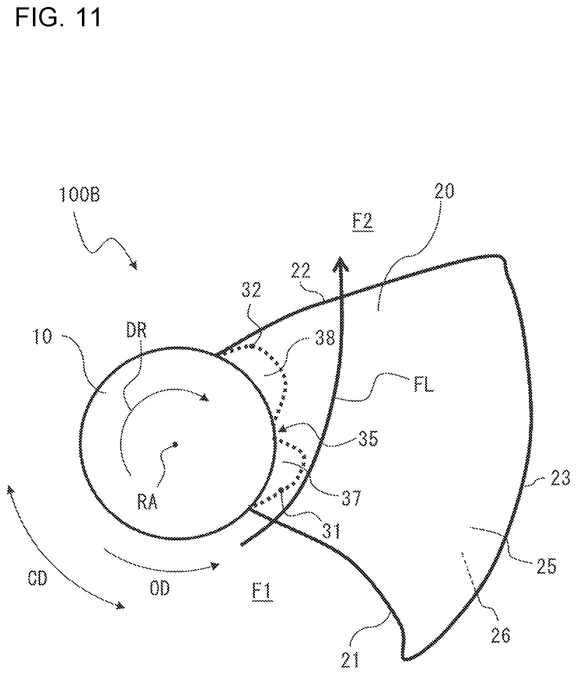

FIG. 11 is a conceptual diagram illustrating the relationship between the air flow FL and the blade 20 of the axial flow fan 100B according to Embodiment 3. In FIG. 11, a space F1 is located on an inlet side where a gas flows to the blade 20, and a space F2 is located on an outlet side where the gas leaves the blade 20. The thickness portion 30 extending from the leading edge 21 in the circumferential direction CD is interrupted in the circumferential direction CD. This results in a reduction in frictional resistance between the air flow FL and the thickness portion 30.

As illustrated in FIG. 11, a centrifugal force causes the air flow FL flowing along the blade 20 of the axial flow fan 100B to flow outward in the radial direction as the air flow travels from the leading edge 21 to the trailing edge 22. The air flow FL flowing along the blade 20 passes through a position apart outward in the radial direction from a segment of the thickness portion 30 that follows the intermediate part 35 in the circumferential direction CD and that is adjacent to the trailing edge 22. The flow resistance is less susceptible to the trailing thickness segment 38.

The trailing thickness segment 38 of the blade 20 leads to an increase in blade thickness in the outward radial direction, thus increasing the rigidity of the blade 20. This reduces movement of the blade 20 in the axial direction of the rotation axis RA. Therefore, the axial flow fan 100B according to Embodiment 3 achieves a reduction in flow resistance of the blade 20 and an increase in rigidity of the blade 20 resulting from an increase in strength thereof.

### Embodiment 4

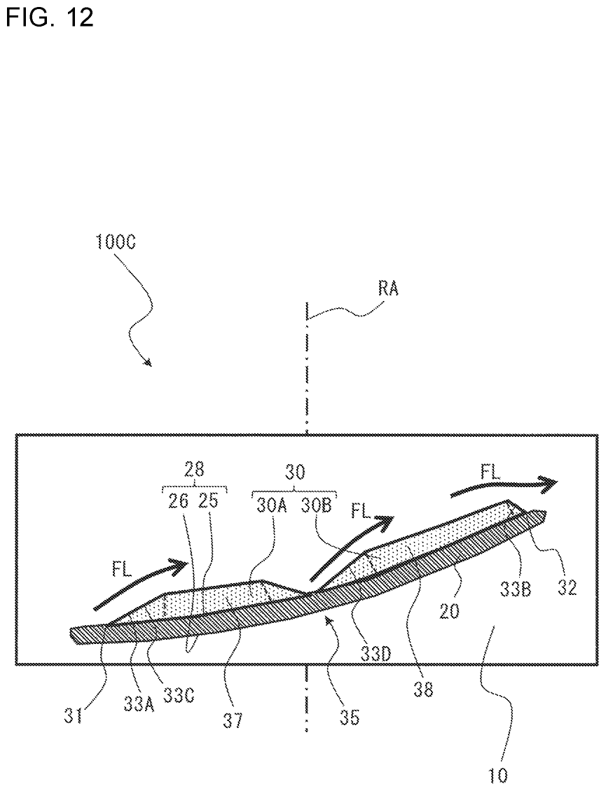

FIG. 12 is a conceptual diagram of an axial flow fan 100C according to Embodiment 4 illustrating a cross-section of a blade 20 taken along line B-B extending along the reference circle R in FIG. 2. The axial flow fan 100C according to Embodiment 4 will be described with reference to FIG. 12. The axial flow fan 100C according to Embodiment 4 specifies the form of the thickness portion 30. The same components and parts as those of the axial flow fan 100 and the other axial flow fans in FIGS. 1 to FIG. 11 are designated by the same reference signs, and a description thereof is omitted.

The axial flow fan 100C according to Embodiment 4 has a form in which the thickness portion 30 of each blade 20 includes segments arranged in the circumferential direction CD. The axial flow fan 100C is configured such that at least a portion of each of the segments of the thickness portion 30 that is located adjacent to the leading edge 21 has a tapered shape in section.

More specifically, as illustrated in FIG. 12, the leading thickness segment 37 of the thickness portion 30 includes a leading edge side tip portion 33C, which is a tip portion adjacent to the leading edge 21, in a cross-section of the thickness portion 30 taken along the reference circle R or a cross-section of the thickness portion 30 taken along a circle parallel to the reference circle R. The leading edge side tip portion 33C is tapered. The leading edge side tip portion 33C defines a slope and has a thickness increasing in the direction from the leading edge 21 to the trailing edge 22. As illustrated in FIG. 12, the leading edge side tip portion 33C of the leading thickness segment 37 may coincide with the first tip portion 33A of the first thickness portion 30A.

Furthermore, as illustrated in FIG. 12, the trailing thickness segment 38 of the thickness portion 30 includes a trailing edge side tip portion 330, which is a tip portion adjacent to the leading edge 21, in the cross-section of the thickness portion 30 taken along the reference circle R or a cross-section of the thickness portion 30 taken along a circle parallel to the reference circle R. The trailing edge side tip portion 33D is tapered. The trailing edge side tip portion 33D defines a slope and has a thickness increasing in the direction from the leading edge 21 to the trailing edge 22.

### [Advantages of Axial Flow Fan 100C]

The leading edge side tip portion 33C, which is the tip portion adjacent to the leading edge 21, of the leading thickness segment 37 is tapered in the cross-section of the thickness portion 30 taken along the reference circle R or a cross-section of the thickness portion 30 taken along a circle parallel to the reference circle R. In addition, the trailing edge side tip portion 33D, which is the tip portion adjacent to the leading edge 21, of the trailing thickness segment 38 is tapered in the cross-section of the thickness portion 30 taken along the reference circle R or a cross-section of the thickness portion 30 taken along a circle parallel to the reference circle R. In the axial flow fan 100C, such tapered portions of the blade 20 adjacent to the leading edge 21 allow an air flow flowing to the thickness portion 30 to smoothly flow along the blade 20 without separating from the blade 20 at the inlet side of the blade 20.

Furthermore, the second tip portion 33B, which is the tip portion adjacent to the trailing edge 22, of the trailing thickness segment 38 is tapered. The blade 20 allows an air flow to smoothly flow along the tapered second tip portion 33B at the trailing edge 22, thus reducing a tip vortex that is caused by the flow of air leaving the thickness portion 30 at the trailing edge 22.

### Embodiment 5

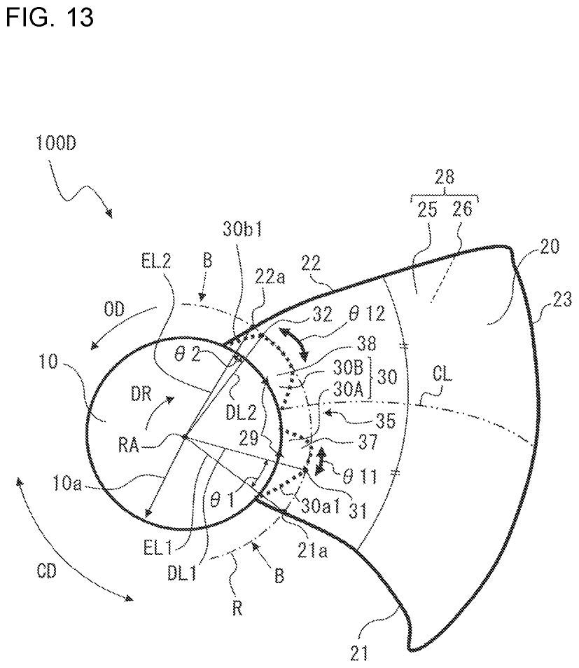

FIG. 13 is a front view of an axial flow fan 100D according to Embodiment 5 illustrating a schematic form of a blade 20. The axial flow fan 100D according to Embodiment 5 specifies the form of the thickness portion 30. The same components and parts as those of the axial flow fan 100 and the other axial flow fans in FIGS. 1 to 12 are designated by the same reference signs, and a description thereof is omitted.

The thickness portion 30 of the axial flow fan 100D according to Embodiment 5 includes segments arranged in the circumferential direction CD. The thickness portion 30 of each blade 20 includes the leading thickness segment 37 located closest to the leading edge 21 and the trailing thickness segment 38 located closest to the trailing edge 22. The axial flow fan 100D is configured such that the thickness portion 30 of the blade 20 includes discrete segments arranged in the circumferential direction CD at a certain radius. The thickness portion 30 illustrated in FIG. 13 includes the intermediate part 35, in which the thickness portion 30 is not formed, the leading thickness segment 37 located between the intermediate part 35 and the leading edge 21, and the trailing thickness segment 38 located between the intermediate part 35 and the trailing edge 22.

A formation area of the leading thickness segment 37 and a formation area of the trailing thickness segment 38 at the same position in the radial direction will now be compared with each other. A phase angle θ11 is defined as an angle formed by the rotation axis RA with opposite ends of the leading thickness segment 37 in the circumferential direction CD. Furthermore, a phase angle θ12 is defined as an angle formed by the rotation axis RA with opposite ends of the trailing thickness segment 38 in the circumferential direction CD.

The axial flow fan 100D is configured such that the phase angle θ12 of the trailing thickness segment 38 is larger than the phase angle θ11 of the leading thickness segment 37 at the same position in the radial direction. Therefore, the blade 20 has a form in which the dimension of the trailing thickness segment 38 in the circumferential direction CD is larger than the dimension of the leading thickness segment 37 in the circumferential direction CD in a cross-section of the thickness portion 30 taken along the reference circle R or a cross-section of the thickness portion 30 taken along a circle parallel to the reference circle R.

### [Advantages of Axial Flow Fan 100D]

The blade 20 of the axial flow fan 100D is formed such that the dimension of the trailing thickness segment 38 in the circumferential direction CD is larger than the dimension of the leading thickness segment 37 in the circumferential direction CD in the cross-section of the thickness portion 30 taken along the reference circle R or a cross-section of the thickness portion 30 taken along a circle parallel to the reference circle R. The leading thickness segment 37 extending from the leading edge 21 has a small dimension in the direction of an air flow. This results in a reduction in frictional resistance between the thickness portion 30 and the air flow.

The trailing thickness segment 38 of the blade 20 leads to an increase in blade thickness in the outward radial direction, thus increasing the rigidity of the blade 20. This reduces movement of the blade 20 in the axial direction of the rotation axis RA. Therefore, the axial flow fan 100D according to Embodiment 5 achieves a reduction in flow resistance of the blade 20 and an increase in rigidity of the blade 20 resulting from an increase in strength thereof.

### Embodiment 6

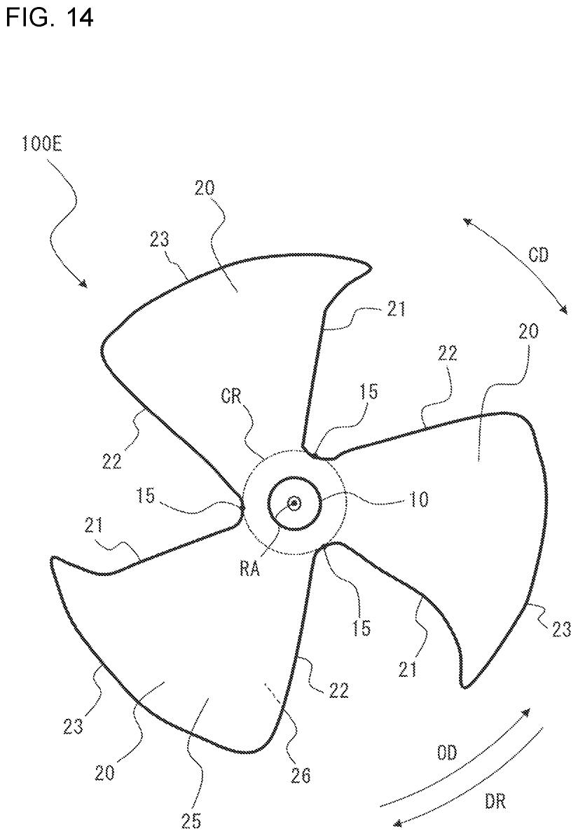

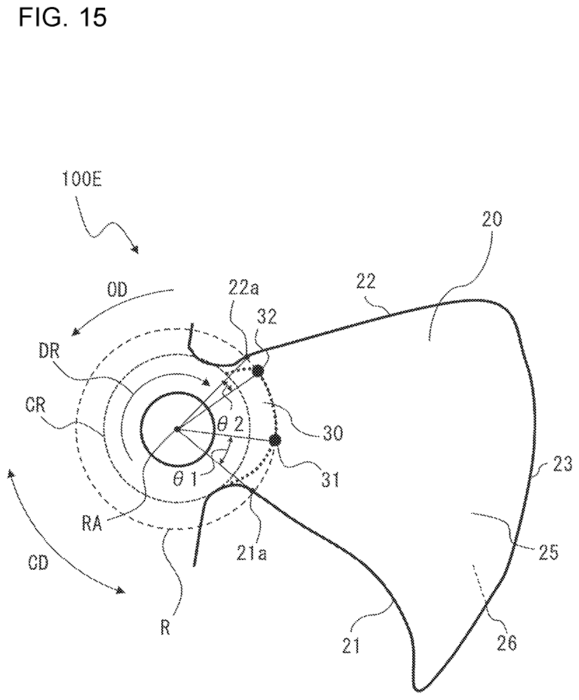

FIG. 14 is a front view of an axial flow fan 100E according to Embodiment 6 illustrating a schematic configuration of the axial flow fan. FIG. 15 is a front view of the axial flow fan 100E according to Embodiment 6 illustrating a schematic form of a blade 20. The axial flow fan 100E according to Embodiment 6 specifies the structure of the axial flow fan 100. The same components and parts as those of the axial flow fan 100 and the other axial flow fans in FIGS. 1 to 13 are designated by the same reference signs, and a description thereof is omitted.

The axial flow fan 100E includes the hub 10 having a small diameter, and has a structure in which the adjacent blades 20 are directly joined together without using the hub 10. In the axial flow fan 100E, a maximum radius of a connection 15, at which the blades 20 are joined together, will be referred to a connection radius CR. The thickness portion 30 is located closer to the outer circumferential side than the connection radius CR in the structure in which the adjacent blades 20 are directly joined together without using the hub 10, as illustrated in FIG. 15.

The axial flow fan 100E is configured such that the phase angle θ1 is larger than the phase angle θ2 at a position closer to the outer circumferential side than the connection radius CR (phase angle θ1>phase angle θ2). In the axial flow fan 100E, therefore, a distance from the leading edge 21 to the thickness portion 30 is longer than a distance from the trailing edge 22 to the thickness portion 30.

### [Advantages of Axial Flow Fan 100E]

The axial flow fan 100E is configured such that the phase angle θ1 is larger than the phase angle θ2 at a position closer to the outer circumferential side than the connection radius CR. Like the axial flow fan 100, the axial flow fan 100E with such a configuration achieves an increase in rigidity of the blade 20 and a reduction in flow resistance of the blade 20. For other advantages, since the axial flow fan 100E is configured such that the phase angle θ1 is larger than the phase angle θ2 at a position closer to the outer circumferential side than the connection radius CR, the axial flow fan 100E exhibits the same advantages as those of the axial flow fan 100.

### Embodiment 7

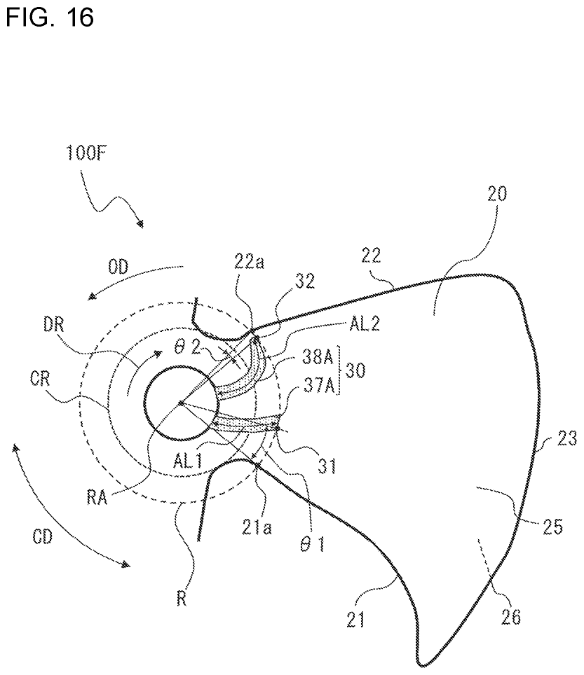

FIG. 16 is a front view of an axial flow fan 100E according to Embodiment 7 illustrating a schematic form of a blade 20. The axial flow fan 100E according to Embodiment 7 specifies the form of the thickness portion 30. The same components and parts as those of the axial flow fan 100 and the other axial flow fans in FIGS. 1 to 15 are designated by the same reference signs, and a description thereof is omitted. For the axial flow fan 100F according to Embodiment 7, the thickness portion 30 is rib-shaped.

The thickness portion 30 of the axial flow fan 100F includes segments arranged in the circumferential direction CD. The thickness portion 30 of each blade 20 includes a leading thickness segment 37A located closest to the leading edge 21 and a trailing thickness segment 38A located closest to the trailing edge 22. The leading thickness segment 37A has the first intersection 31, and the trailing thickness segment 38A has the second intersection 32. The leading thickness segment 37A specifies the form of the leading thickness segment 37 in Embodiment 3, and the trailing thickness segment 38A specifies the form of the trailing thickness segment 38 in Embodiment 3.

The leading thickness segment 37A and the trailing thickness segment 38A extend in the radial direction in a plan view seen in the axial direction of the rotation axis RA, and each have a tip that curves in the anti-rotation direction OD as the thickness segment extends from the inner circumferential side toward the outer circumferential side. In other words, the tip of each of the leading thickness segment 37A and the trailing thickness segment 38A curves in the direction opposite to the rotation direction DR as the thickness segment extends from the inner circumferential side toward the outer circumferential side.

The thickness portion 30 of the axial flow fan 100F according to Embodiment 7 includes the segments arranged in the circumferential direction CD. The thickness portion 30 of each blade 20 includes the rib-shaped leading thickness segment 37A and the rib-shaped trailing thickness segment 38A. The blade 20 of the axial flow fan 100F has a form in which the curvature of the trailing thickness segment 38A of the curved thickness portion 30 is larger than the curvature of the leading thickness segment 37A.

The blade 20 of the axial flow fan 100F is formed such that, in the plan view seen in the axial direction of the rotation axis RA, the length, AL2, of the trailing thickness segment 38A extending from the inner circumferential side toward the outer circumferential side is longer than the length, AL1, of the leading thickness segment 37A extending from the inner circumferential side toward the outer circumferential side.

The axial flow fan 100F according to Embodiment 7 is configured such that the phase angle θ1 is larger than the phase angle θ2 (phase angle θ1>phase angle θ2).

### [Advantages of Axial Flow Fan 100E]

The leading thickness segment 37A and the trailing thickness segment 38A extend in the radial direction in the plan view seen in the axial direction of the rotation axis RA. The tip of each of these thickness segments curves in the anti-rotation direction OD as the thickness segment extends from the inner circumferential side toward the outer circumferential side. In other words, the thickness portion 30 of the axial flow fan 100F according to Embodiment 7 includes the segments arranged in the circumferential direction CD. The thickness portion 30 of each blade 20 includes the rib-shaped leading thickness segment 37A and the rib-shaped trailing thickness segment 38A. The thickness portion 30, which includes the rib-shaped leading thickness segment 37A and the rib-shaped trailing thickness segment 38A, of the axial flow fan 100F according to Embodiment 7 achieves a reduction in weight of the blade 20 and an increase in rigidity of the blade 20.

The axial flow fan 100F according to Embodiment 7 is configured such that the phase angle θ1 is larger than the phase angle θ2 (phase angle θ1>phase angle θ2). Like the axial flow fan 100 according to Embodiment 1, the axial flow fan 100F according to Embodiment 7 therefore achieves both a reduction in flow resistance at the leading edge 21 and an increase in rigidity at the trailing edge 22.

The thickness portion 30 extending from a position adjacent to the leading edge 21 in the circumferential direction CD is interrupted in the circumferential direction CD. This results in a reduction in frictional resistance between the air flow FL (see FIG. 11) and the thickness portion 30. Furthermore, a centrifugal force causes the air flow FL flowing along the blade 20 of the axial flow fan 100E to flow outward in the radial direction as the air flow travels from the leading edge 21 to the trailing edge 22. Therefore, the air flow FL flowing along the blade 20 passes through a position apart outward in the radial direction from the trailing thickness segment 38A. The flow resistance is less susceptible to the trailing thickness segment 38A.

The blade 20 is formed such that the curvature of the trailing thickness segment 38A is larger than that of the leading thickness segment 37A. In the axial flow fan 100F, therefore, the rib-shaped trailing thickness segment 38A having a larger curvature increases the strength of the blade 20 at the trailing edge 22 of the blade 20, thus increasing the rigidity of the blade 20. An increase in rigidity of the blade 20 due to the trailing thickness segment 38A reduces movement of the blade 20 in the axial direction of the rotation axis RA. Therefore, the axial flow fan 100F according to Embodiment 7 achieves a reduction in flow resistance of the blade 20 and an increase in rigidity of the blade 20 resulting from an increase in strength thereof.

The blade 20 is formed such that, in the plan view seen in the axial direction of the rotation axis RA, the length of the trailing thickness segment 38A extending from the inner circumferential side toward the outer circumferential side is longer than the length of the leading thickness segment 37A extending from the inner circumferential side toward the outer circumferential side. The trailing thickness segment 38A of the blade 20 leads to an increase in blade thickness in the outward radial direction, thus increasing the rigidity of the blade 20. This reduces movement of the blade 20 in the axial direction of the rotation axis RA. Therefore, the axial flow fan 100E according to Embodiment 7 achieves a reduction in flow resistance of the blade 20 and an increase in rigidity of the blade 20 resulting from an increase in strength thereof.

### Embodiment 8

### [Refrigeration Cycle Apparatus 70]

A refrigeration cycle apparatus 70 according to Embodiment 8 will be described. The refrigeration cycle apparatus 70 includes an outdoor unit 50, serving as an air-sending device that includes any of the axial flow fan 100 and the other axial flow fans according to Embodiments 1 to 7 described above.

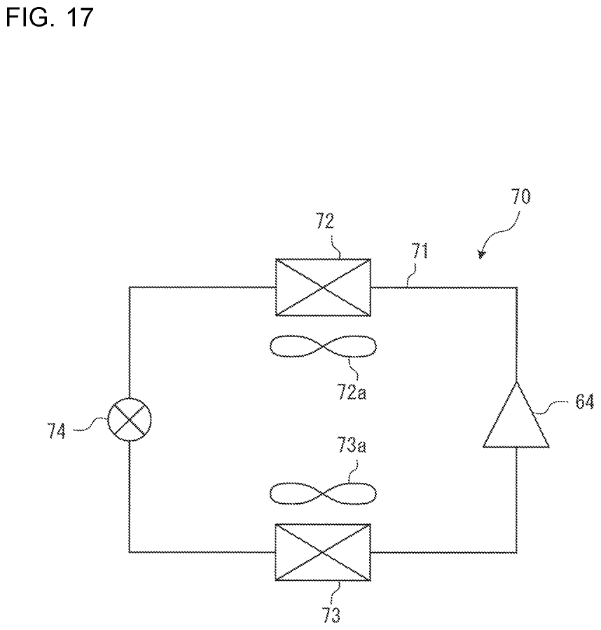

FIG. 17 is a schematic diagram of the refrigeration cycle apparatus 70 according to Embodiment 8. Although the refrigeration cycle apparatus 70 used for air conditioning will be described below, the refrigeration cycle apparatus 70 may be used in any other application. The refrigeration cycle apparatus 70 is used for, for example, refrigeration or air conditioning, and can be used as, for example, a refrigerator, a freezer, a vending machine, an air-conditioning apparatus, a refrigeration apparatus, or a water heater.

As illustrated in FIG. 17, the refrigeration cycle apparatus 70 includes a refrigerant circuit 71 in which a compressor 64, a condenser 72, an expansion valve 74, and an evaporator 73 are sequentially connected by refrigerant pipes. The condenser 72 is provided with a condenser fan 72a, which sends air for heat exchange to the condenser 72. The evaporator 73 is provided with an evaporator fan 73a, which sends air for heat exchange to the evaporator 73. At least the condenser fan 72a or the evaporator fan 73a is any of the axial flow fan 100 and the other axial flow fans according to Embodiments 1 to 7. The refrigeration cycle apparatus 70 may be configured such that the refrigerant circuit 71 includes a flow switching device, such as a four-way valve, to switch between refrigerant flow directions, and may switch between a heating operation and a cooling operation.

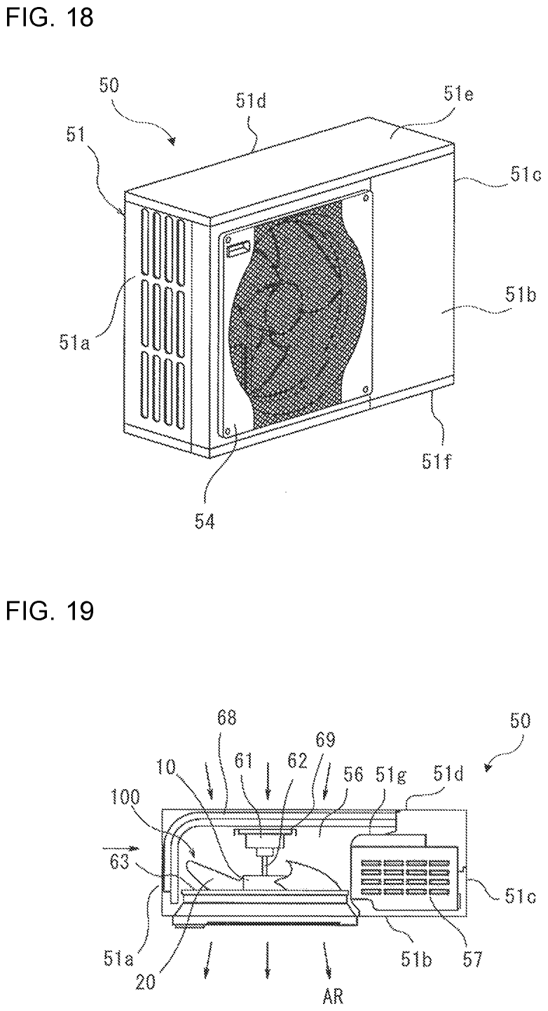

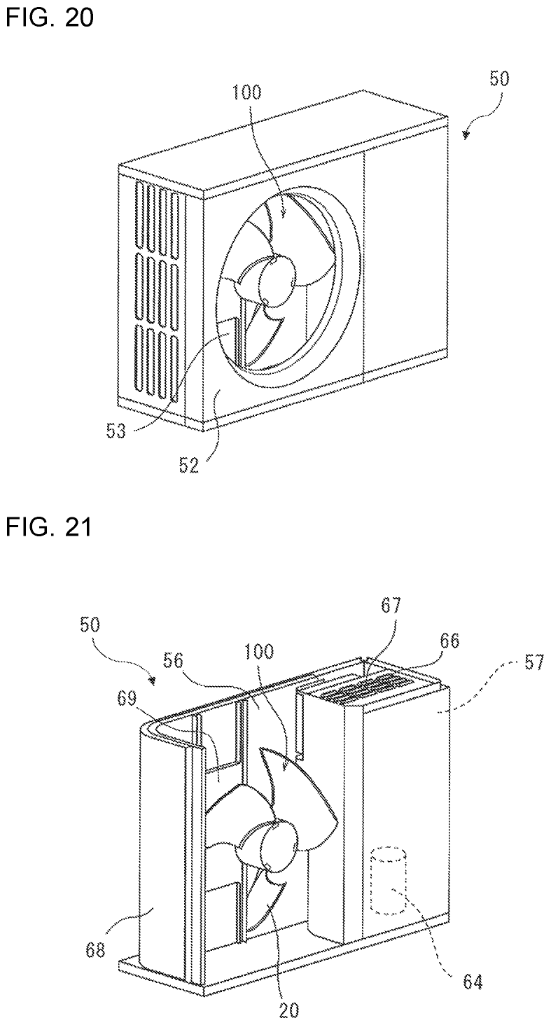

FIG. 18 is a perspective view of the outdoor unit 50, serving as an air-sending device, as viewed from where an air outlet is located. FIG. 19 is a top view of the outdoor unit 50 illustrating the configuration of the outdoor unit 50. FIG. 20 is a perspective view of the outdoor unit 50 with a fan grille 54 removed. FIG. 21 is a perspective view of the outdoor unit 50 with the fan grille 54, a front panel, and other parts removed and illustrates an internal configuration of the outdoor unit.

As illustrated in FIGS. 18 to 21, an outdoor unit body 51 is a casing having a pair of sides, or a left side 51a and a right side 51c, a front surface 51b, a rear surface 51d, a top surface 51e, and a bottom surface 51f. The side 51a and the rear surface 51d each have openings (not illustrated) through which external air is taken into the casing. The front surface 51b includes a front panel 52 having an air outlet 53, serving as an opening through which air is blown to the outside. Furthermore, the air outlet 53 is covered with the fan grille 54 to prevent contact between the axial flow fan 100 and, for example, an object outside the outdoor unit body 51, for safety. In FIG. 19, arrows AR represent the flow of air.

The outdoor unit body 51 contains the axial flow fan 100 and a fan motor 61. The axial flow fan 100 is connected to the fan motor 61, serving as a driving source, located adjacent to the rear surface 51d by a rotating shaft 62. The axial flow fan 100 is driven and rotated by the fan motor 61. The fan motor 61 applies a driving force to the axial flow fan 100. The fan motor 61 is mounted on a motor support 69. The motor support 69 is disposed between the fan motor 61 and a heat exchanger 68.

An internal space of the outdoor unit body 51 is separated by a partition 51g, serving as a wall, into two parts, an air-sending chamber 56 containing the axial flow fan 100 and a machine chamber 57 containing, for example, the compressor 64. The heat exchanger 68 having a substantially L-shape in plan view is located adjacent to the side 51a and the rear surface 51d in the air-sending chamber 56. The heat exchanger 68 may have any other shape. The heat exchanger 68 operates as the evaporator 73 in the heating operation, and operates as the condenser 72 in the cooling operation.

The bell mouth 63 is disposed radially outside the axial flow fan 100 disposed in the air-sending chamber 56. The bell mouth 63 surrounds the outer circumferential side of the axial flow fan 100 and regulates the flow of a gas current produced by the axial flow fan 100, for example, The bell mouth 63 is located outside the outer circumferential edges of the blades 20, and has a circular shape along the rotation direction DR of the axial flow fan 100, The partition 51g is located at one side of the bell mouth 63, and part of the heat exchanger 68 is located at an opposite side of the bell mouth 63 from the partition 51g.

The bell mouth 63 has a front end joined to the front panel 52 of the outdoor unit 50 to surround the rim of the air outlet 53. The bell mouth 63 may be integrally formed with the front panel 52 or may be separate from and connectable to the front panel 52. The bell mouth 63 defines an air passage in proximity to the air outlet 53 such that the air passage is located between an inlet side of the bell mouth 63 and an outlet side thereof. In other words, the bell mouth 63 separates the air passage in proximity to the air outlet 53 from the rest of the air-sending chamber 56.

The heat exchanger 68, which is provided adjacent to the inlet side of the axial flow fan 100, includes multiple fins arranged with, for example, their flat surfaces parallel to one another, and heat transfer tubes extending through the fins in a direction in which the fins are arranged. The refrigerant, which is circulated through the refrigerant circuit, flows through the heat transfer tubes. In the heat exchanger 68 in Embodiment 8, the heat transfer tubes extend in an L shape along the side 51a and the rear surface 51d of the outdoor unit body 51 such that the heat transfer tubes at different rows meander while extending through the fins. The heat exchanger 68 is connected to the compressor 64 by, for example, a pipe (not illustrated), and is further connected to, for example, an indoor heat exchanger and an expansion valve, which are not illustrated, thus forming the refrigerant circuit 71 of the air-conditioning apparatus. The machine chamber 57 contains a board box 66. The board box 66 accommodates a control board 67, which controls the devices arranged in the outdoor unit.

### [Advantages of Refrigeration Cycle Apparatus 70 and Air-Sending Device]

Embodiment 8 offers the same advantages as those of Embodiments 1 to 7 described above. For example, the refrigeration cycle apparatus 70 and the air-sending device achieve an increase in rigidity of each blade 20 of, for example, the axial flow fan 100, and a reduction in flow resistance of the blade 20. Furthermore, in the refrigeration cycle apparatus 70 and the air-sending device, each thickness portion 30 of the axial flow fan 100 reduces vibration of the blade 20, thus reducing air flow turbulence that is creased by the blade 20 due to vibration of the blade 20. This results in a reduction in noise caused by air flow turbulence.

The configurations illustrated in the aforementioned embodiments are examples, and can be combined with another known technique or can be partly omitted or modified without departing from the spirit and scope of the present disclosure.

### REFERENCE SIGNS LIST

10: hub, 10a: hub outside diameter, 15: connection, 20: blade, 21: leading edge, 21a: first edge portion, 22: trailing edge, 22a: second edge portion, 22e: trailing edge end, 23: outer edge, 24: inner edge, 25: pressure surface, 26: suction surface, 28: blade surface, 29: root, 30: thickness portion, 30A: first thickness portion, 30B: second thickness portion, 30a1: edge portion, 30b1: edge portion, 31: first intersection, 32: second intersection, 33A: first tip portion, 33B: second tip portion, 33C: leading edge side tip portion, 33D: trailing edge side tip portion, 34: ridge line, 35: intermediate part, 37: leading thickness segment, 37A: leading thickness segment, 38: trailing thickness segment, 38A: trailing thickness segment, 50: outdoor unit, 51: outdoor unit body, 51a: side, 51b: front surface, 51c: side, 51d: rear surface, 51e: top surface, 51f: bottom surface, 51g: partition, 52: front panel, 53: air outlet, 54: fan grille, 56: air-sending chamber, 57: machine chamber, 61: fan motor, 62: rotating shaft, 63: bell mouth, 64: compressor, 66: board box, 67: control board, 68: heat exchanger, 69: motor support, 70: refrigeration cycle apparatus, 71: refrigerant circuit, 72: condenser, 72a: condenser fan, 73: evaporator, 73a: evaporator fan, 74: expansion valve, 100: axial flow fan, 100A: axial flow fan, 100B: axial flow fan, 100C: axial flow fan, 100D: axial flow fan, 100E: axial flow fan, 100F: axial flow fan, AR: arrow, CD: circumferential direction, CL: center line, CR: connection radius, DL1: thickness portion first straight line, DL2: thickness portion second straight line, DR: rotation direction, EL1: edge portion first straight line, EL2: edge portion second straight line, F: direction, F1: space, F2: space, FL: air flow, OD: anti-rotation direction, R: reference circle, RA: rotation axis, SA: extent, SB1: extent, SB2: extent, T: blade height, T1: maximum blade height, T2: maximum blade height, VP: point of view, θ1: phase angle, θ11: phase angle, θ12: phase angle, θ2: phase angle

1. An axial flow fan comprising:
a hub configured to be driven to rotate and serve as a rotation axis; and
a blade provided around the hub and having a leading edge and a trailing edge,
the blade having, at a root on the hub side thereof, a thickness portion being a protrusion provided at a blade surface of the blade, wherein
a phase angle θ1 is larger than a phase angle θ2
where
with a virtual line passing through a midpoint of the blade in a circumferential direction of the blade being a center line,
the thickness portion includes
a first thickness portion being on the leading edge side of the center line, and
a second thickness portion being on the trailing edge side of the center line, and
in a plan view seen in an axial direction of the rotation axis,
a virtual circle around the rotation axis as a center thereof, passing through an outermost one of virtual circles passing through both the first thickness portion and the second thickness portion, is a reference circle,
an intersection of the reference circle and an edge portion of the first thickness portion, the intersection being at an extremity in a rotation direction of the blade is a first intersection,
an intersection of the reference circle and an edge portion of the second thickness portion, the intersection being at an extremity in an anti-rotation direction, being inverse of the rotation direction, of the blade is a second intersection,
an intersection of the reference circle and the leading edge is a first edge portion,
an intersection of the reference circle and the trailing edge is a second edge portion,
a virtual straight line passing through the rotation axis and the first intersection is a thickness portion first straight line,
a virtual straight line passing through the rotation axis and the second intersection is a thickness portion second straight line,
a virtual straight line passing through the rotation axis and the first edge portion is an edge portion first straight line,
a virtual straight line passing through the rotation axis and the second edge portion is an edge portion second straight line,
an angle between the thickness portion first straight line and the edge portion first straight line is the phase angle θ1, and
an angle between the thickness portion second straight line and the edge portion second straight line is the phase angle θ2,
wherein, in a cross-section of the thickness portion taken along the reference circle or a cross-section of the thickness portion taken along a circle parallel to the reference circle, the thickness portion includes a first tip portion being a tip portion adjacent to the leading edge, and the first tip portion is tapered.

2. The axial flow fan of claim 1, wherein the thickness portion is provided at a pressure surface of the blade.

3. (canceled)

4. The axial flow fan of claim 1, wherein, in the cross-section of the thickness portion taken along the reference circle or the cross-section of the thickness portion taken along the circle parallel to the reference circle, the thickness portion includes a second tip portion being a tip portion adjacent to the trailing edge, and the second tip portion is tapered.

5. The axial flow fan of claim 4, wherein
where
a distance between a blade surface at which the thickness portion is not provided and a ridge line of the thickness portion between the first tip portion and the second tip portion is a blade height,
the blade height on the trailing edge side is larger than the blade height on the leading edge side.

6. The axial flow fan of claim 1, wherein
where
a distance between a blade surface at which the thickness portion is not provided and a ridge line of the thickness portion is a blade height,
the second thickness portion has a maximum blade height larger than a maximum blade height of the first thickness portion.

7. The axial flow fan of claim 5, wherein the blade has a form in which the blade height gradually increases in a direction from the leading edge to the trailing edge.

8. The axial flow fan of claim 1, wherein
the thickness portion includes segments arranged in the circumferential direction and includes a leading thickness segment located closest to the leading edge and a trailing thickness segment located closest to the trailing edge,
the leading thickness segment has the first intersection, and
the trailing thickness segment has the second intersection.

9. The axial flow fan of claim 8, wherein
in a cross-section of the thickness portion taken along the reference circle or a cross-section of the thickness portion taken along a circle parallel to the reference circle,
the leading thickness segment includes a leading edge side tip portion that is a tip portion adjacent to the leading edge and that is tapered, and
the trailing thickness segment includes a trailing edge side tip portion that is a tip portion adjacent to the leading edge and that is tapered.

10. The axial flow fan of claim 8, wherein the blade has a form in which, in a cross-section of the thickness portion taken along the reference circle or a cross-section of the thickness portion taken along a circle parallel to the reference circle, the trailing thickness segment has a larger dimension in the circumferential direction than the leading thickness segment.

11. The axial flow fan of claim 8, wherein, in the plan view seen in the axial direction of the rotation axis, the leading thickness segment and the trailing thickness segment extend in a radial direction of the axial flow fan and each have a tip that curves in the direction opposite to the rotation direction as the thickness segment extends from an inner circumferential side of the axial flow fan toward an outer circumferential side of the axial flow fan.

12. The axial flow fan of claim 11, wherein the blade has a form in which the trailing thickness segment has a larger curvature than the leading thickness segment.

13. The axial flow fan of claim 11, wherein the blade has a form in which, in the plan view seen in the axial direction of the rotation axis, a length of the trailing thickness segment extending from the inner circumferential side toward the outer circumferential side is longer than a length of the leading thickness segment extending from the inner circumferential side toward the outer circumferential side.

14. An air-sending device comprising:
the axial flow fan of claim 1;
a driving source configured to apply a driving force to the axial flow fan;
a bell mouth covering a part of an outer circumferential edge of the blade, the part being adjacent to the trailing edge; and
a casing containing the axial flow fan and the driving source.

15. A refrigeration cycle apparatus comprising:
the air-sending device of claim 14; and
a refrigerant circuit including a condenser and an evaporator,
wherein the air-sending device is configured to send air to at least the condenser or the evaporator.

16. An axial flow fan comprising:
a hub configured to be driven to rotate and serve as a rotation axis; and
a blade provided around the hub and having a leading edge and a trailing edge,
the blade having, at a root on the hub side thereof, a thickness portion being a protrusion provided at a blade surface of the blade, wherein
a phase angle θ1 is larger than a phase angle θ2
where
with a virtual line passing through a midpoint of the blade in a circumferential direction of the blade being a center line,
the thickness portion includes
a first thickness portion being on the leading edge side of the center line, and
a second thickness portion being on the trailing edge side of the center line, and
in a plan view seen in an axial direction of the rotation axis,
a virtual circle around the rotation axis as a center thereof, passing through an outermost one of virtual circles passing through both the first thickness portion and the second thickness portion, is a reference circle,
an intersection of the reference circle and an edge portion of the first thickness portion, the intersection being at an extremity in a rotation direction of the blade is a first intersection,
an intersection of the reference circle and an edge portion of the second thickness portion, the intersection being at an extremity in an anti-rotation direction, being inverse of the rotation direction, of the blade is a second intersection,
an intersection of the reference circle and the leading edge is a first edge portion,
an intersection of the reference circle and the trailing edge is a second edge portion,
a virtual straight line passing through the rotation axis and the first intersection is a thickness portion first straight line,
a virtual straight line passing through the rotation axis and the second intersection is a thickness portion second straight line,
a virtual straight line passing through the rotation axis and the first edge portion is an edge portion first straight line,
a virtual straight line passing through the rotation axis and the second edge portion is an edge portion second straight line,
an angle between the thickness portion first straight line and the edge portion first straight line is the phase angle θ1, and
an angle between the thickness portion second straight line and the edge portion second straight line is the phase angle θ2,
wherein
where
a distance between a blade surface at which the thickness portion is not provided and a ridge line of the thickness portion is a blade height, and
the second thickness portion has a maximum blade height larger than a maximum blade height of the first thickness portion.

17. An axial flow fan comprising:
a hub configured to be driven to rotate and serve as a rotation axis; and
a blade provided around the hub and having a leading edge and a trailing edge,
the blade having, at a root on the hub side thereof, a thickness portion being a protrusion provided at a blade surface of the blade, wherein
a phase angle θ1 is larger than a phase angle θ2
where
with a virtual line passing through a midpoint of the blade in a circumferential direction of the blade being a center line,
the thickness portion includes
a first thickness portion being on the leading edge side of the center line, and
a second thickness portion being on the trailing edge side of the center line, and
in a plan view seen in an axial direction of the rotation axis,
a virtual circle around the rotation axis as a center thereof, passing through an outermost one of virtual circles passing through both the first thickness portion and the second thickness portion, is a reference circle,
an intersection of the reference circle and an edge portion of the first thickness portion, the intersection being at an extremity in a rotation direction of the blade is a first intersection,
an intersection of the reference circle and an edge portion of the second thickness portion, the intersection being at an extremity in an anti-rotation direction, being inverse of the rotation direction, of the blade is a second intersection,
an intersection of the reference circle and the leading edge is a first edge portion,
an intersection of the reference circle and the trailing edge is a second edge portion,
a virtual straight line passing through the rotation axis and the first intersection is a thickness portion first straight line,
a virtual straight line passing through the rotation axis and the second intersection is a thickness portion second straight line,
a virtual straight line passing through the rotation axis and the first edge portion is an edge portion first straight line,
a virtual straight line passing through the rotation axis and the second edge portion is an edge portion second straight line,
an angle between the thickness portion first straight line and the edge portion first straight line is the phase angle θ1, and
an angle between the thickness portion second straight line and the edge portion second straight line is the phase angle θ2,
wherein
the thickness portion includes segments arranged in the circumferential direction and includes a leading thickness segment located closest to the leading edge and a trailing thickness segment located closest to the trailing edge,
the leading thickness segment has the first intersection, and
the trailing thickness segment has the second intersection, and
wherein
in a cross-section of the thickness portion taken along the reference circle or a cross-section of the thickness portion taken along a circle parallel to the reference circle,
the leading thickness segment includes a leading edge side tip portion that is a tip portion adjacent to the leading edge and that is tapered, and
the trailing thickness segment includes a trailing edge side tip portion that is a tip portion adjacent to the leading edge and that is tapered.

18. An axial flow fan comprising:
a hub configured to be driven to rotate and serve as a rotation axis; and
a blade provided around the hub and having a leading edge and a trailing edge,
the blade having, at a root on the hub side thereof, a thickness portion being a protrusion provided at a blade surface of the blade, wherein
a phase angle θ1 is larger than a phase angle θ2
where
with a virtual line passing through a midpoint of the blade in a circumferential direction of the blade being a center line,
the thickness portion includes
a first thickness portion being on the leading edge side of the center line, and
a second thickness portion being on the trailing edge side of the center line, and
in a plan view seen in an axial direction of the rotation axis,
a virtual circle around the rotation axis as a center thereof, passing through an outermost one of virtual circles passing through both the first thickness portion and the second thickness portion, is a reference circle,
an intersection of the reference circle and an edge portion of the first thickness portion, the intersection being at an extremity in a rotation direction of the blade is a first intersection,
an intersection of the reference circle and an edge portion of the second thickness portion, the intersection being at an extremity in an anti-rotation direction, being inverse of the rotation direction, of the blade is a second intersection,
an intersection of the reference circle and the leading edge is a first edge portion,
an intersection of the reference circle and the trailing edge is a second edge portion,
a virtual straight line passing through the rotation axis and the first intersection is a thickness portion first straight line,
a virtual straight line passing through the rotation axis and the second intersection is a thickness portion second straight line,
a virtual straight line passing through the rotation axis and the first edge portion is an edge portion first straight line,
a virtual straight line passing through the rotation axis and the second edge portion is an edge portion second straight line,
an angle between the thickness portion first straight line and the edge portion first straight line is the phase angle θ1, and
an angle between the thickness portion second straight line and the edge portion second straight line is the phase angle θ2,
wherein
the thickness portion includes segments arranged in the circumferential direction and includes a leading thickness segment located closest to the leading edge and a trailing thickness segment located closest to the trailing edge,
the leading thickness segment has the first intersection, and
the trailing thickness segment has the second intersection, and
wherein the blade has a form in which, in a cross-section of the thickness portion taken along the reference circle or a cross-section of the thickness portion taken along a circle parallel to the reference circle, the trailing thickness segment has a larger dimension in the circumferential direction than the leading thickness segment.

19. An axial flow fan comprising:
a hub configured to be driven to rotate and serve as a rotation axis; and
a blade provided around the hub and having a leading edge and a trailing edge,
the blade having, at a root on the hub side thereof, a thickness portion being a protrusion provided at a blade surface of the blade, wherein
a phase angle θ1 is larger than a phase angle θ2
where
with a virtual line passing through a midpoint of the blade in a circumferential direction of the blade being a center line,
the thickness portion includes
a first thickness portion being on the leading edge side of the center line, and
a second thickness portion being on the trailing edge side of the center line, and
in a plan view seen in an axial direction of the rotation axis,
a virtual circle around the rotation axis as a center thereof, passing through an outermost one of virtual circles passing through both the first thickness portion and the second thickness portion, is a reference circle,
an intersection of the reference circle and an edge portion of the first thickness portion, the intersection being at an extremity in a rotation direction of the blade is a first intersection,
an intersection of the reference circle and an edge portion of the second thickness portion, the intersection being at an extremity in an anti-rotation direction, being inverse of the rotation direction, of the blade is a second intersection,
an intersection of the reference circle and the leading edge is a first edge portion,
an intersection of the reference circle and the trailing edge is a second edge portion,
a virtual straight line passing through the rotation axis and the first intersection is a thickness portion first straight line,
a virtual straight line passing through the rotation axis and the second intersection is a thickness portion second straight line,
a virtual straight line passing through the rotation axis and the first edge portion is an edge portion first straight line,
a virtual straight line passing through the rotation axis and the second edge portion is an edge portion second straight line,
an angle between the thickness portion first straight line and the edge portion first straight line is the phase angle θ1, and
an angle between the thickness portion second straight line and the edge portion second straight line is the phase angle θ2,
wherein
the thickness portion includes segments arranged in the circumferential direction and includes a leading thickness segment located closest to the leading edge and a trailing thickness segment located closest to the trailing edge,
the leading thickness segment has the first intersection, and
the trailing thickness segment has the second intersection, and
wherein, in the plan view seen in the axial direction of the rotation axis, the leading thickness segment and the trailing thickness segment extend in a radial direction of the axial flow fan and each have a tip that curves in the direction opposite to the rotation direction as the thickness segment extends from an inner circumferential side of the axial flow fan toward an outer circumferential side of the axial flow fan, and
wherein the blade has a form in which, in the plan view seen in the axial direction of the rotation axis, a length of the trailing thickness segment extending from the inner circumferential side toward the outer circumferential side is longer than a length of the leading thickness segment extending from the inner circumferential side toward the outer circumferential side.
